(19) United States
(12) Patent Application Publication
(10) Pub. No.: US 2019/0210407 A1
(43) Pub. Date: Jul. 11, 2019

(54) TIRE

(71) Applicant: BRIDGESTONE CORPORATION, Chuo-ku, Tokyo (JP)

(72) Inventor: Tomohiro HIRAISHI, Bunkyo-ku, Tokyo (JP)

(73) Assignee: BRIDGESTONE CORPORATION, Chuo-ku, Tokyo (JP)

(21) Appl. No.: 16/303,306

(22) PCT Filed: Jun. 13, 2017
(86) PCT No.: PCT/JP2017/021861

§ 371 Date: Nov. 20, 2018

(30) Foreign Application Priority Data
Jun. 13, 2016 (JP) 2016-117229

(51) Int. Cl. B60C 11/00; B60C 11/03; B60C 11/12

(52) U.S. Cl. CPC B60C 11/0083; B60C 11/1272; B60C 11/1236; B60C 11/0302

(57) ABSTRACT

Provided is a tire, comprising a tread surface divided into a plurality of land portions by at least one circumferential groove extending along a tire equator and tread edges, wherein at least one of the land portions divided by the at least one circumferential groove and the tread edges comprises a plurality of blocks divided by a plurality of width direction grooves; each of the blocks has a shape that protrudes from four sides toward a central portion; and each of the width direction grooves comprises a sipe portion.

### TECHNICAL FIELD

The present disclosure relates to tires, particularly to high performance tires having high drainage performance, braking performance and turning performance.

### BACKGROUND

Conventionally, particularly in the field of high performance tires, it is known to enlarge blocks in order to improve the block rigidity during load rolling. For example; PTL 1 discloses a tire in which blocks are enlarged to improve the block rigidity, and thereby the cornering force (CF) characteristics are improved.

### CITATION LIST

### Patent Literature

PTL 1: JPH 10-297216 A

### SUMMARY

### Technical Problem

When the blocks of a tire tread are enlarged as described above; the block rigidity is improved; however, there is a problem that the grounding property in the blocks deteriorates especially during high speed rolling of the tire. That is, during rolling of the tire, when a load is applied to the tread surface, the force concentrates on the boundaries between the groove bottom and the groove walls of each width direction groove, such that a stress is generated toward the inside of each block from the side walls of the block, causing deformation that the end portions in the width direction of each block are pushed up. As a result, the ground contact pressure at the central portion of each block becomes lower than the surroundings. Particularly, at the time of high speed rotation, the ground contact pressure of the tire tread surface is higher than that at the time of low speed rotation, such that deterioration of the grounding property inside each block becomes remarkable. As described above, the grounding property in each block becomes non-uniform, such that the drainage performance, braking performance and turning performance might have not been sufficiently improved. In other words, the larger the blocks, the greater the difference in ground contact pressure between the central portion and the end portions of each block, such that the problem remains in that the effect of enlarging the blocks cannot be sufficiently enjoyed.

It is an object of the present disclosure to provide a high performance tire that improves the grounding property of blocks, and thereby further improving the drainage performance, braking performance and turning performance.

### Solution to Problem

The inventor conducted a diligent investigation in order to solve the above problem. Through this investigation, the inventor discovered that in order to increase the ground contact pressure at the central portion of a block, it is effective to adopt a shape that protrudes toward the central portion. On the other hand, since the rubber of the protruding portion swells toward the sides of the block at the time of grounding, it was found that a protruding shape is not such useful for increasing the ground contact pressure at the central portion. Then, it was found that by forming a part of each width direction groove like a sipe having a very narrow opening width, the rubber of the protruding portion can be prevented from swelling toward the sides of the block, and the adjacent blocks protrude in a manner supported by each other, enabling an increase in ground contact pressure at the central portion. That is, the inventor discovered that in order to avoid deterioration in grounding property of a block, it is effective to adopt a shape that protrudes toward the central portion of the block and suppress swelling of the protruding rubber toward width direction grooves by forming a part of each width direction groove to be a sipe, and thereby completed the present disclosure.

The subject of this disclosure is as follows.

(1) A tire, comprising a tread surface divided into a plurality of land portions by at least one circumferential groove extending along a tire equator and tread edges, wherein at least one of the land portions divided by the at least one circumferential groove and the tread edges comprises a plurality of blocks divided by a plurality of width direction grooves; each of the blocks has a shape that protrudes from four sides toward a central portion; and each of the width direction grooves comprises a sipe portion.

Here, a “ground contact width” in the present disclosure refers to the maximum straight line distance in the tread width direction on a contact surface with a flat plate, when the tire is mounted on an applicable rim and placed perpendicularly to the flat plate in a stationary state with the air pressure set to be a prescribed value, and a load corresponding to a prescribed mass is applied thereto. Further, a “ground contact length” refers to the maximum straight line distance in the tread circumferential direction on the same contact surface.

Furthermore, an “applicable rim” refers to a rim prescribed by an industrial standard which is valid in an area where the tire is manufactured and used, and examples of the industrial standard include: “JATMA (The Japan Automobile Tyre Manufacturers Association, Inc.) YEAR BOOK” of Japan; “STANDARDS MANUAL” of ETRTO (The European Tyre and Rim Technical Organisation) of Europe; and “TRA (THE TIRE AND RIM ASSOCIATION INC.) Year Book” of the United States.

### Advantageous Effect

According to the present disclosure, a high performance tire having high drainage performance, braking performance and turning performance can be provided.

### BRIEF DESCRIPTION OF THE DRAWINGS

In the accompanying drawings:

FIG. 1 is a developed view illustrating a tread surface of a tire according to a first embodiment of the present disclosure;

FIG. 2 is a partially enlarged view taken of FIG. 1;

FIG. 3A is a cross-sectional view taken from line A-A in FIG. 1;

FIG. 3B is a cross-sectional view taken from line B-B in FIG. 1;

FIG. 3C is a cross-sectional view taken from line C-C in FIG. 1;

FIG. 4 illustrates another embodiment of A-A section in FIG. 1; and

FIG. 5 is a developed view illustrating a tread surface of a tire according to a second embodiment of the present disclosure.

### DETAILED DESCRIPTION

Hereinafter, a pneumatic tire of the present disclosure (hereinafter also referred to as “the tire”) is described in details with reference to the accompanying drawings by exemplifying embodiments thereof.

Although it is omitted in the drawings, a regular tire structure comprising a pair of sidewall portions respectively extending from a pair of bead portions in a radially outward direction; a carcass composed of an organic fiber cord or a steel cord ply extending from one bead portion to the other bead portion through a crown portion including a tread portion formed to extend between the sidewall portions; and a belt composed of a steel cord layer disposed between the carcass and the tread.

### First Embodiment

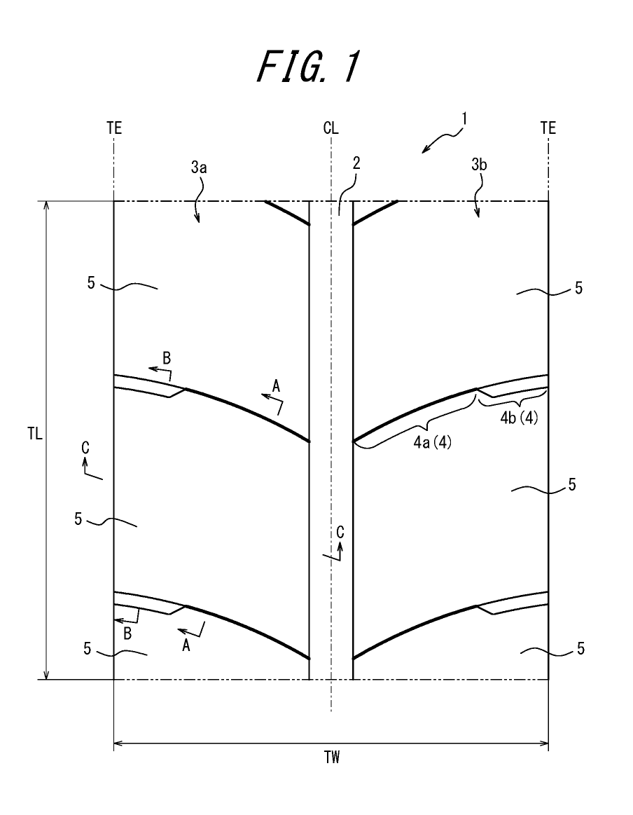

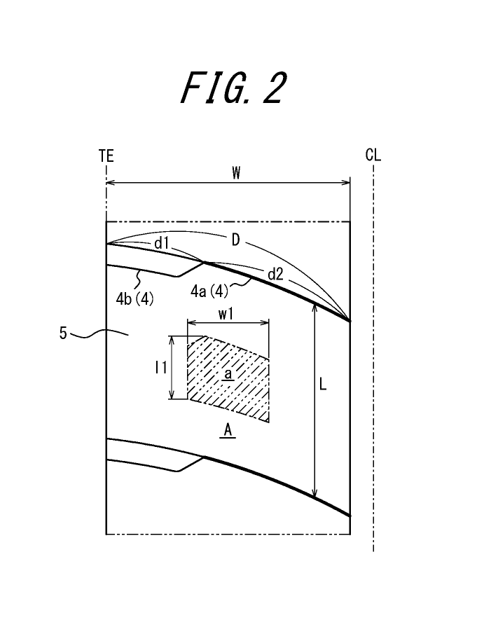

FIG. 1 is a developed view illustrating a tread surface of a tire according to a first embodiment of the present disclosure; and FIG. 2 is a partially enlarged view thereof. In the present tire, a tread surface 1 of the tread (Hereinafter; it is referred to as “the tread surface”.) is divided into a plurality of land portions 3a and 3b by at least one circumferential groove extending along a tire equator CL, specifically, a circumferential groove 2 in the illustrated example, and tread edges TE.

At least one of the land portions 3a and 3b, specifically, both of the land portions 3a and 3b in the illustrated example; are divided into a plurality of blocks 5 by a plurality of width direction grooves 4 communicating with the circumferential groove 2 and the tread edges TE. The circumferential groove 2 and the width direction grooves 4 are provided in the tread to ensure drainage performance.

Here, each width direction groove 4 is constituted by a sipe portion 4a extending from the circumferential groove 2 to a tread edge TE side and a groove portion 4b extending from the sipe portion 4a to the tread edge TE side. A sipe portion is a groove having an extremely narrow width such that it closes in the tread footprint during rolling of the tire, and a groove portion is a groove having a width such that it remains open in the tread footprint.

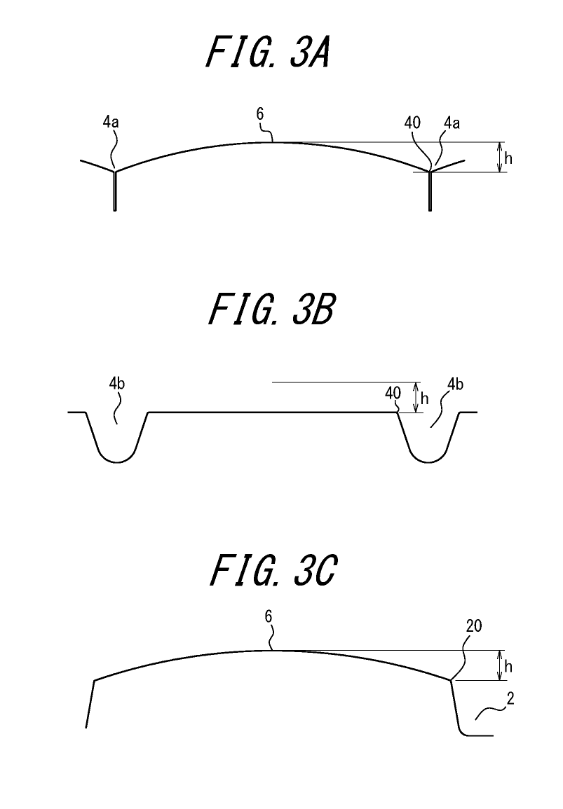

Each block 5 has a shape that protrudes from the four sides of the block 5 toward the central portion. Regarding this protruding shape, cross-sectional views taken from line A-A, line B-B and line C-C in FIG. 1 are respectively illustrated in FIGS. 3A, 3B and 3C. As illustrated in these cross-sectional views, the block 5 has a shape that protrudes from the four sides of the block to the central portion conforming to an arc.

As described above, in the case that the block 5 defined by the circumferential groove 2 and the width direction grooves 4 is a conventional one whose surface is substantially flat, the ground contact pressure at the end portions of the block is higher than that at the central portion. On the contrary, according to the present disclosure, since the ground contact pressure of the central portion when the block grounds can be increased by adopting a shape that protrudes from the four sides of the block toward the central portion, the ground contact pressure difference between the central portion and the end portions becomes extremely small. Here, during rolling of the tire, if the rubber of the central portion which preferentially contacts the road surface swells and deforms toward the width direction groove sides of the block, it becomes difficult to enjoy the effect of increase in ground contact pressure due to the aforementioned protrusion of the central portion, and therefore it is essential to provide a sipe portion 4a in each width direction groove 4. Provided with the sipe portion 4a, swelling deformation of the block rubber toward the width direction groove 4 sides is suppressed, and therefore an increase in ground contact pressure due to the protrusion of the block central portion is realized.

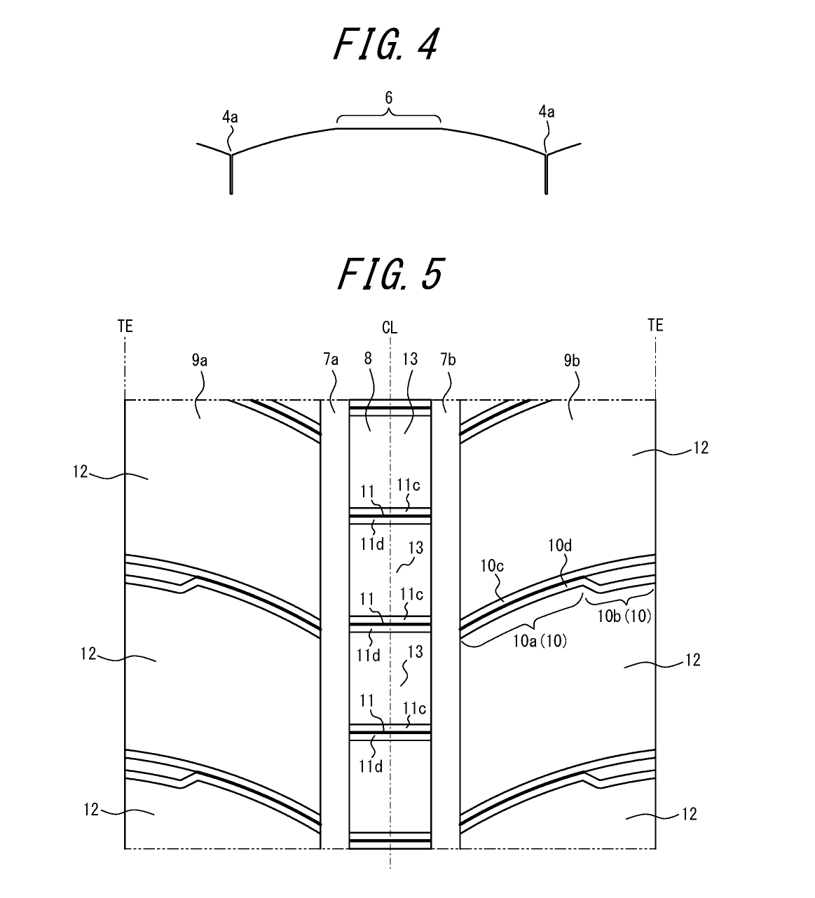

As illustrated in FIGS. 3A, 3B and 3C, the block 5 has a shape that protrudes from the four sides which are respectively in contact with the circumferential groove 2, the tread edge TE and the width direction grooves 4 defining the block 5 to an apex 6, conforming to an arc shape in the illustrated example. By forming the block 5 into such a shape to protrude toward the apex 6 in the form of, for example, an arc, it is possible to increase the ground contact pressure of the central portion when the block grounds, and thereby suppressing the ground contact pressure difference between the central portion and the end portions. Additionally, such a protruding shape also contributes to make it easier for moisture in the ground contact region of the tread to be discharged toward the circumferential groove 2, the tread edges TE, and the width direction grooves 4 when grounding on a road surface. Further, in the FIGS. 3A, 3B and 3C, the apex 6 is the apex of the protrusion; however, as illustrated in FIG. 4, it may have a certain area spreading at the same height.

Here, each width direction groove 4 includes a sipe portion 4a. The sipe portion 4a may be disposed at a tire tread edge side, or at the central portion of the width direction groove 4; however, is preferably disposed at the tire equator side. Since the ground contact pressure distribution on the tread surface during straight running becomes higher at the central portion than at the tread edges; by suppressing swelling deformation of the block portion at the tire equator side having a higher ground contact pressure in the block, equalization of the ground contact pressure distribution of the entire block 5 can be reliably achieved.

In the present disclosure, as illustrated in FIG. 2, it is preferable that the sipe portion 4a has a longitudinal direction (the sipe extension direction) length d1 that is 30% to 90% of the total longitudinal direction length D of the width direction groove 4. This is because, by setting it to be 30% or more, swelling deformation of the block rubber toward the width direction groove when the central portion of the block 5 grounds on a road surface is sufficiently suppressed. Preferably, 55% to 65% is effective for realizing better suppression effect of swelling deformation of the block 5. On the other hand, by setting it to be 90% or less; swelling deformation of the block rubber toward the width direction groove 4 side is suppressed without causing deterioration in drainage performance.

In the present disclosure; it is preferable that the sipe portion 4a of the width direction groove 4 has an opening width of 0.05 mm to 0.5 mm. By defining the opening width of the sipe portion 4a as described above, it is possible to more effectively suppress swelling deformation of the block 5 toward the side surface, and suppress the grounding property difference between the end portions and the central portion of the block 5. Further, it is possible to minimize reduction in rigidity due to formation of the width direction groove 4.

The opening width of the sipe portion 4a is more preferably 0.05 mm to 0.4 mm, and further preferably 0.05 mm to 0.3 mm. With such a configuration, it is possible to prevent reduction in rigidity of the block 5, while more effectively equalizing the ground contact pressure distribution of the block. Further, in order to ensure sufficient drainage performance by the width direction groove 4, it is preferable that the groove portion 4b has an opening width of 0.1 mm to 0.5 mm.

In the present disclosure, as illustrated in FIG. 2, in the planar view, it is preferable that the apex 6 has an area (area “a”) that is ¼ or less of the total area A of the block 5. Thereby, equalization of the ground contact pressure due to provision of the apex 6 can be realized more effectively. It is more preferably ⅙ or less, and further preferably 1/9 or less.

Also, it is preferable that, the apex 6 has a tread width direction maximum length w1 that is 30% to 40% of the width direction length W of the block; and the apex 6 has a tread circumferential direction maximum length 11 that is 30% to 40% of the circumferential direction length L of the block. With such a configuration, it is possible to suppress decrease in footprint area of the block even if the load applied to the tread surface is relatively low.

In the protrusion of the block, it is preferable that the apex 6 is located within the overlapping region between the intermediate portion when the width direction length W of the block 5 is equally divided into three and the intermediate portion when the circumferential direction length L of the block 5 is equally divided into three. With such a configuration, the ground contact pressure distribution of the block 5 can be further equalized. In the case that the block 5 is not rectangular, it is preferable that the overlapping region has a shape along the sides constituting the block 5 and substantially similar to the block 5. Further, as illustrated in FIG. 2, it is possible to provide a notch parallel to the end portion of the groove portion 4b of the width direction groove LL The same applies to the shape of the apex 6.

It is preferable that the presently disclosed block 5 protrudes from the opening edge 40 of each width direction groove 4 and the opening edge 20 of the circumferential groove 2 toward the central portion. In FIGS. 3A, 3B and 3C, the radial direction height from the opening edge 40 of the width direction groove 4 to the apex 6 and the radial direction height from the opening edge 20 of the circumferential groove 2 to the apex 6 are indicated as h.

Regarding the protrusion of the block, it is preferable that the block 5 has a tire radial direction height h up to the apex 6 and a width direction length W that satisfy the following equation:

0.01≤h/W≤0.023.

When h/W is less than the lower limit, the grounding property cannot be improved. On the other hand, when h/W exceeds the upper limit, the footprint area decreases.

Further, regarding the protrusion of the block, it is preferable that the tire radial direction height h from the opening edge 40 of the width direction groove 4 to the apex 6 is 0.5 mm to 1.5 mm. This is because, by providing a sufficient height difference between the end portions and the central portion of the block, it becomes easy for the rubber at the central portion to preferentially contact the road surface during rolling of the tire. When it is 0.5 mm or more, equalization of the ground contact pressure distribution can be achieved; however, when it exceeds 1.5 mm, the footprint area decreases, which may result in deterioration in grounding property. It is more preferably 0.8 mm to 1.0 mm. Thereby, the ground contact pressure can be further equalized.

It is preferable that the width direction length W of the block 5 is 28% to 70% with respect to the ground contact width TW of the tire. With such a configuration, it is possible to ensure block rigidity that is enough to compete with side forces during high speed turning, which leads to improvement in movement performance.

It is more preferably 33% to 42%, and further preferably 36% to 40%. By setting this numerical range, it is possible to equalize the ground contact pressure distribution at a high level while maintaining sufficient block rigidity.

It is preferable that the circumferential direction length L of the block 5 is 35% to 49% with respect to the ground contact length TL of the tire. That is, during acceleration and deceleration of the vehicle, an input acting in the circumferential direction is generated in the tire; however, by having such a configuration, it is possible to ensure block rigidity that is enough to compete with such an input and improve the movement performance.

It is more preferably 38% to 46%, and further preferably 41% to 44%. By setting this numerical range, it is possible to equalize the ground contact pressure distribution at a high level while maintaining sufficient block rigidity.

### Second Embodiment

Next, a tire according to a second embodiment of the present disclosure is described with reference to FIG. 5. FIG. 5 is a developed view illustrating the tread surface of the tire according to the second embodiment of the present disclosure. Components in FIG. 5 that are similar to those in FIG. 1 are given the same reference signs as in FIG. 1 and the description thereof is omitted. As illustrated in FIG. 5, in this tire, the tread surface 1 is divided into three land portions by two circumferential grooves 7a and 7b extending along the tire equator CL and the tread edges TE. In the illustrated example, a central land portion 8 defined by the circumferential grooves 7a and 7b, and shoulder land portions 9a and 9b respectively defined by the circumferential groove 7a and a tread edge TE and by the circumferential groove 7b and the other tread edge TE are formed.

The shoulder land portions 9a and 9b are divided into a plurality of blocks 12 by a plurality of width direction grooves 10. The width direction grooves 10 and the blocks 12 have the same configuration as that of the width direction grooves 4 and the blocks 5 in FIG. 1. By disposing land portions having such a configuration at the tread edges sides of the tire, higher turning performance can be ensured. That is, since the ground contact pressure distribution in the tread width direction of the tire during turning becomes higher in the areas adjacent to the tread edges than the central portion, by equalizing the ground contact pressure distribution in the areas adjacent to the tread edges, the turning performance can be improved. Further, moisture in the ground contact region of the tread can be easily discharged when grounding on a road surface.

On the other hand, the central land portion 8, as illustrated, is divided into a plurality of blocks 13 by a plurality of sipes 11 extending in the tread width direction.

Like the blocks 5 in the first embodiment, the blocks 13 preferably have a shape that protrudes toward the central portion. Thereby, even in the vicinity of the tire equator, the ground contact pressure distribution of each block can be equalized, and the drainage performance can be improved. Further, during rolling of the tire, if the rubber of each central portion which preferentially contacts the road surface swells and deforms, it becomes difficult to enjoy the effect of increase in ground contact pressure due to protrusion of the central portions. Therefore; by dividing the blocks 13 by the sipes 11, swelling deformation of the block rubbers toward the sipe 11 sides is suppressed, and as a result, an increase in ground contact pressure due to protrusion of the central portion of each block is realized.

As illustrated, each sipe 11 has a certain opening width, and similarly to the width direction grooves 4 in FIG. 1, may be constituted by a sipe portion and a groove portion. By setting a part thereof to have an opening width that is substantially the same as that of the groove portion 4b of each width direction groove 4, better drainage performance can be ensured.

Here, since the central land portion 8 is divided into a plurality of blocks 13 by a plurality of sipes 11, and the blocks 13 have a protruding shape, it is possible to increase the ground contact pressure at the central portions and improve the drainage performance when the blocks 13 ground.

Additionally, the sipe portion 10a and groove portion 10b of each width direction groove 10 may have chamfers 10c and 10d applied to the opening edges, and each sipe 11 may have chamfers 11c and 11d applied to the opening edges. With such a configuration, the drainage performance can be improved.

### EXAMPLES

The following describes Examples of the disclosure; however, the disclosure is in no way limited thereto.

Tires of size 205/55R16 according to the tread patterns illustrated in FIG. 1 and FIG. 5 were respectively trial-manufactured under the conditions listed in Table 1. Note that the depths of each circumferential direction groove, width direction groove and sipe are 4 mm for all Sample Tires.
After attaching each obtained Sample Tire to a rim (having a size of 7.0 J) with an internal pressure of 240 kPa, it was assembled to a rear wheel drive vehicle of 2000 cc displacement, and thereafter, the drainage performance, braking performance and turning performance were evaluated when the vehicle runs on a test course (dry road surface and wet road surface included) with a driver riding.

[Turning Performance] [Braking Performance]

For each of the above tires, the turning performance and braking performance when running on a dry road surface were evaluated by sensory evaluation by the driver. The results were indicated as a relative value taking the evaluation results of Sample Tire 1 as 100. Note that the larger the value, the better the performance.

### [Drainage Performance]

For each of the above tires, the running performance during running on a wet road surface (having a water depth of 1 mm) was evaluated by sensory evaluation by the driver. The result was evaluated as a relative value taking the evaluation result of Sample Tire 1 as 100. Note that the larger the value, the better the drainage performance.

TABLE 1

| | Sample | Sample | Sample | Sample | Sample | Sample | Sample |
|---|---|---|---|---|---|---|---|
| | Tire 1 | Tire 2 | Tire 3 | Tire 4 | Tire 5 | Tire 6 | Tire 7 |
| Width direction groove | None | Yes | Yes | Yes | Yes | Yes | Yes |
| Sipe portion | — | None | Yes | Yes | Yes | Yes | Yes |
| Protrusion of block | — | None | None | Yes | Yes | Yes | Yes |
| Position of sipe portion | — | — | Tire equator | Tire equator | Tire equator | Tire equator | Tire equator |
| | | | side | side | side | side | side |
| Longitudinal direction | — | — | 65% | 50% | 65% | 65% | 65% |
| length d1 of sipe portion | | | | | | | |
| 4a/longitudinal direction | | | | | | | |
| length D of width direction | | | | | | | |
| groove 4 | | | | | | | |
| Opening width of sipe | — | — | 0.3 mm | 0.3 mm | 0.3 mm | 0.3 mm | 0.3 mm |
| portion 4a | | | | | | | |
| Area a of apex/area A | — | — | — | 1/9 | 1/9 | 1/9 | 1/9 |
| of block | | | | | | | |
| Width direction length w1 | — | — | — | 30% | 30% | 30% | 30% |
| of apex/width direction | | | | | | | |
| length W of block | | | | | | | |
| Circumferential direction | — | — | — | 30% | 30% | 30% | 30% |
| length l1 of apex/ | | | | | | | |
| circumferential direction | | | | | | | |
| length L of block | | | | | | | |
| Position of apex of | — | — | — | Intermidiate | Intermidiate | End | Intermidiate |
| protrusion (trisection) | | | | portion | portion | portion | portion |
| Radial height h of apex | — | — | — | 1.0 mm | 1.0 mm | 1.0 mm | 0.47 mm |
| Radial height h of apex/ | — | — | — | 0.020 | 0.020 | 0.020 | 0.009 |
| width direction length | | | | | | | |
| W of block | | | | | | | |
| Width direction length W | — | — | 40% | 32% | 40% | 40% | 40% |
| of block/ground contact | | | | | | | |
| width TW of tire | | | | | | | |
| Circumferential direction | — | — | 44% | 40% | 44% | 44% | 44% |
| length L of block/ground | | | | | | | |
| contact length TL of tire | | | | | | | |
| Width direction length W | — | — | 50 mm | 50 mm | 50 mm | 50 mm | 50 mm |
| of block | | | | | | | |
| Circumferential direction | — | — | 50 mm | 60 mm | 50 mm | 50 mm | 50 mm |
| length L of block | | | | | | | |
| Drainage performance | 100 | 120 | 125 | 141 | 140 | 120 | 133 |
| Braking performance | 100 | 98 | 99 | 107 | 110 | 101 | 104 |
| Turning performance | 100 | 98 | 99 | 108 | 110 | 101 | 107.5 |
| Remarks | Comparative | Comparative | Comparative | Example | Example | Example | Example |
| | Example | Example | Example | | | | |

| | Sample | Sample | Sample | Sample | Sample |
|---|---|---|---|---|---|
| | Tire 8 | Tire 9 | Tire 10 | Tire 11 | Tire 12 |
| Width direction groove | Yes | Yes | Yes | Yes | Yes |
| Sipe portion | Yes | Yes | Yes | Yes | Yes |
| Protrusion of block | Yes | Yes | Yes | Yes | Yes |
| Position of sipe portion | Tire equator | Tire equator | Tire equator | Tire equator | Tire equator |
| | side | side | side | side | side |
| Longitudinal direction | 65% | 65% | 65% | 65% | 65% |
| length d1 of sipe portion | | | | | |
| 4a/longitudinal direction | | | | | |
| length D of width direction | | | | | |
| groove 4 | | | | | |
| Opening width of sipe | 0.3 mm | 0.3 mm | 0.3 mm | 03 mm | 0.3 mm |
| portion 4a | | | | | |
| Area a of apex/area A | 1/9 | 1/9 | 1/9 | 1/9 | 1/9 |
| of block | | | | | |
| Width direction length w1 | 30% | 30% | 30% | 30% | 30% |
| of apex/width direction | | | | | |
| length W of block | | | | | |
| Circumferential direction | 30% | 30% | 30% | 30% | 30% |
| length l1 of apex/ | | | | | |
| circumferential direction | | | | | |
| length L of block | | | | | |
| Position of apex of | Intermidiate | Intermidiate | Intermidiate | Intermidiate | Intermidiate |
| protrusion (trisection) | portion | portion | portion | portion | portion |
| Radial height h of apex | 1.3 mm | 0.30 mm | 1.6 mm | 0.6 mm | 1.1 mm |
| Radial height h of apex/ | 0.026 | 0.006 | 0.032 | 0.012 | 0.022 |
| width direction length | | | | | |
| W of block | | | | | |
| Width direction length W | 40% | 40% | 40% | 40% | 40% |
| of block/ground contact | | | | | |
| width TW of tire | | | | | |
| Circumferential direction | 44% | 44% | 44% | 44% | 44% |
| length L of block/ground | | | | | |
| contact length TL of tire | | | | | |
| Width direction length W | 50 mm | 50 mm | 50 mm | 50 mm | 50 mm |
| of block | | | | | |
| Circumferential direction | 50 mm | 50 mm | 50 mm | 50 mm | 50 mm |
| length L of block | | | | | |
| Drainage performance | 145 | 128 | 148 | 135 | 142 |
| Braking performance | 104 | 103 | 101.5 | 108 | 106 |
| Turning performance | 105 | 103 | 101.5 | 108.5 | 107.5 |
| Remarks | Example | Example | Example | Example | Example |

| | Sample | Sample | Sample | Sample | Sample | Sample | Sample |
|---|---|---|---|---|---|---|---|
| | Tire 13 | Tire 14 | Tire 15 | Tire 16 | Tire 17 | Tire 18 | Tire 19 |
| Width direction groove | Yes | Yes | Yes | Yes | Yes | Yes | Yes |
| Sipe portion | Yes | Yes | Yes | Yes | Yes | Yes | Yes |
| Protrusion of block | Yes | Yes | Yes | Yes | Yes | Yes | Yes |
| Position of sipe portion | Tire equator | Tire equator | Tire equator | Tire equator | Tire equator | Tire equator | Tire end |
| | side | side | side | side | side | side | side |
| Longitudinal direction | 65% | 65% | 65% | 65% | 65% | 65% | 65% |
| length d1 of sipe portion | | | | | | | |
| 4a/longitudinal direction | | | | | | | |
| length D of width direction | | | | | | | |
| groove 4 | | | | | | | |
| Opening width of sipe | 0.3 mm | 0.3 mm | 0.3 mm | 0.3 mm | 0.3 mm | 0.3 mm | 0.3 mm |
| portion 4a | | | | | | | |
| Area a of apex/area A | 1/3 | 1/4 | 1/6 | 1/9 | 1/9 | 1/9 | 1/9 |
| of block | | | | | | | |
| Width direction length w1 | 30% | 30% | 30% | 20% | 50% | 40% | 30% |
| of apex/width direction | | | | | | | |
| length W of block | | | | | | | |
| Circumferential direction | 30% | 30% | 30% | 20% | 50% | 40% | 30% |
| length l1 of apex/ | | | | | | | |
| circumferential direction | | | | | | | |
| length L of block | | | | | | | |
| Position of apex of | Intermidiate | Intermidiate | Intermidiate | Intermidiate | Intermidiate | Intermidiate | Intermidiate |
| protrusion (trisection) | portion | portion | portion | portion | portion | portion | portion |
| Radial height h of apex | 1.0 mm | 1.0 mm | 1.0 mm | 1.0 mm | 1.0 mm | 1.0 mm | 1.0 mm |
| Radial height h of apex/ | 0.020 | 0.020 | 0.020 | 0.020 | 0.020 | 0.020 | 0.020 |
| width direction length | | | | | | | |
| W of block | | | | | | | |
| Width direction length W | 40% | 40% | 40% | 40% | 40% | 40% | 40% |
| of block/ground contact | | | | | | | |
| width TW of tire | | | | | | | |
| Circumferential direction | 44% | 44% | 44% | 44% | 44% | 44% | 44% |
| length L of block/ground | | | | | | | |
| contact length TL of tire | | | | | | | |
| Width direction length | 50 mm | 50 mm | 50 mm | 50 mm | 50 mm | 50 mm | 50 mm |
| W of block | | | | | | | |
| Circumferential direction | 50 mm | 50 mm | 50 mm | 50 mm | 50 mm | 50 mm | 50 mm |
| length L of block | | | | | | | |
| Drainage performance | 128 | 133 | 136 | 141 | 138 | 140 | 125 |
| Braking performance | 104.5 | 104.5 | 105 | 106 | 105 | 108 | 110 |
| Turning performance | 103 | 106.5 | 107.5 | 107.5 | 108 | 109 | 110 |
| Remarks | Example | Example | Example | Example | Example | Example | Example |

| | Sample | Sample | Sample | Sample | Sample |
|---|---|---|---|---|---|
| | Tire 20 | Tire 21 | Tire 22 | Tire 23 | Tire 24 |
| Width direction groove | Yes | Yes | Yes | Yes | Yes |
| Sipe portion | Yes | Yes | Yes | Yes | Yes |
| Protrusion of block | Yes | Yes | Yes | Yes | Yes |
| Position of sipe portion | Width direction | Tire equator | Tire equator | Tire equator | Tire equator |
| | groove center | side | side | side | side |
| Longitudinal direction | 65% | 20% | 95% | 30% | 90% |
| length d1 of sipe portion | | | | | |
| 4a/longitudinal direction | | | | | |
| length D of width direction | | | | | |
| groove 4 | | | | | |
| Opening width of sipe | 0.3 mm | 0.3 mm | 0.3 mm | 0.3 mm | 0.3 mm |
| portion 4a | | | | | |
| Area a of apex/area A | 1/9 | 1/9 | 1/9 | 1/9 | 1/9 |
| of block | | | | | |
| Width direction length w1 | 30% | 30% | 30% | 30% | 30% |
| of apex/width direction | | | | | |
| length W of block | | | | | |
| Circumferential direction | 30% | 30% | 30% | 30% | 30% |
| length l1 of apex/ | | | | | |
| circumferential direction | | | | | |
| length L of block | | | | | |
| Position of apex of | Intermidiate | Intermidiate | Intermidiate | Intermidiate | Intermidiate |
| protrusion (trisection) | portion | portion | portion | portion | portion |
| Radial height h of apex | 1.0 mm | 1.0 mm | 1.0 mm | 1.0 mm | 1.0 mm |
| Radial height h of apex/ | 0.020 | 0.020 | 0.020 | 0.020 | 0.020 |
| width direction length | | | | | |
| W of block | | | | | |
| Width direction length W | 40% | 40% | 40% | 40% | 40% |
| of block/ground contact | | | | | |
| width TW of tire | | | | | |
| Circumferential direction | 44% | 44% | 44% | 44% | 44% |
| length L of block/ground | | | | | |
| contact length TL of tire | | | | | |
| Width direction length | 50 mm | 50 mm | 50 mm | 50 mm | 50 mm |
| W of block | | | | | |
| Circumferential direction | 50 mm | 50 mm | 50 mm | 50 mm | 50 mm |
| length L of block | | | | | |
| Drainage performance | 130 | 145 | 120 | 144 | 136 |
| Braking performance | 110 | 103 | 112 | 105 | 111 |
| Turning performance | 110 | 103 | 112 | 107 | 111 |
| Remarks | Example | Example | Example | Example | Example |

| | Sample | Sample | Sample | Sample | Sample | Sample | Sample |
|---|---|---|---|---|---|---|---|
| | Tire 25 | Tire 26 | Tire 27 | Tire 28 | Tire 29 | Tire 30 | Tire 31 |
| Width direction groove | Yes | Yes | Yes | Yes | Yes | Yes | Yes |
| Sipe portion | Yes | Yes | Yes | Yes | Yes | Yes | Yes |
| Protrusion of block | Yes | Yes | Yes | Yes | Yes | Yes | Yes |
| Position of sipe portion | Tire equator | Tire equator | Tire equator | Tire equator | Tire equator | Tire equator | Tire equator |
| | side | side | side | side | side | side | side |
| Longitudinal direction | 65% | 65% | 65% | 65% | 65% | 65% | 65% |
| length d1 of sipe portion | | | | | | | |
| 4a/longitudinal direction | | | | | | | |
| length D of width direction | | | | | | | |
| groove 4 | | | | | | | |
| Opening width of sipe | 1.0 mm | 0.6 mm | 0.5 mm | 0.3 mm | 0.3 mm | 0.3 mm | 0.3 mm |
| portion 4a | | | | | | | |
| Area a of apex/area A | 1/9 | 1/9 | 1/9 | 1/9 | 1/9 | 1/9 | 1/9 |
| of block | | | | | | | |
| Width direction length w1 | 30% | 30% | 30% | 30% | 30% | 30% | 30% |
| of apex/width direction | | | | | | | |
| length W of block | | | | | | | |
| Circumferential direction | 30% | 30% | 30% | 30% | 30% | 30% | 30% |
| length l1 of apex/ | | | | | | | |
| circumferential direction | | | | | | | |
| length L of block | | | | | | | |
| Position of apex of | Intermidiate | Intermidiate | Intermidiate | Intermidiate | Intermidiate | Intermidiate | Intermidiate |
| protrusion (trisection) | portion | portion | portion | portion | portion | portion | portion |
| Radial height h of apex | 1.0 mm | 1.0 mm | 1.0 mm | 1.0 mm | 1.0 mm | 1.0 mm | 1.0 mm |
| Radial height h of apex/ | 0.020 | 0.020 | 0.020 | 0.020 | 0.020 | 0.020 | 0.020 |
| width direction length | | | | | | | |
| W of block | | | | | | | |
| Width direction length | 40% | 40% | 40% | 27% | 71% | 35% | 65% |
| W of block/ground contact | | | | | | | |
| width TW of tire | | | | | | | |
| Circumferential direction | 44% | 44% | 44% | 44% | 44% | 44% | 44% |
| length L of block/ground | | | | | | | |
| contact length TL of tire | | | | | | | |
| Width direction length W | 50 mm | 50 mm | 50 mm | 50 mm | 50 mm | 50 mm | 50 mm |
| of block | | | | | | | |
| Circumferential direction | 50 mm | 50 mm | 50 mm | 50 mm | 50 mm | 50 mm | 50 mm |
| length L of block | | | | | | | |
| Drainage performance | 141 | 140 | 140 | 140 | 120 | 140 | 137 |
| Braking performance | 103.5 | 103.5 | 107 | 108 | 110 | 108 | 111 |
| Turning performance | 105.5 | 105.5 | 108.5 | 106 | 112 | 108.5 | 111 |
| Remarks | Example | Example | Example | Example | Example | Example | Example |

| | Sample | Sample | Sample | Sample | Sample | Sample |
|---|---|---|---|---|---|---|
| | Tire 32 | Tire 33 | Tire 34 | Tire 35 | Tire 36 | Tire 37 |
| Width direction groove | Yes | Yes | Yes | Yes | Yes | Yes |
| Sipe portion | Yes | Yes | Yes | Yes | Yes | Yes |
| Protrusion of block | Yes | Yes | Yes | Yes | Yes | Yes |
| Position of sipe portion | Tire equator | Tire equator | Tire equator | Tire equator | Tire equator | Tire equator |
| | side | side | side | side | side | side |
| Longitudinal direction | 65% | 65% | 65% | 65% | 65% | 65% |
| length d1 of sipe portion | | | | | | |
| 4a/longitudinal direction | | | | | | |
| length D of width direction | | | | | | |
| groove 4 | | | | | | |
| Opening width of sipe | 0.3 mm | 0.3 mm | 0.3 mm | 0.3 mm | 0.3 mm | 0.3 mm |
| portion 4a | | | | | | |
| Area a of apex/area A | 1/9 | 1/9 | 1/9 | 1/9 | 1/9 | 1/9 |
| of block | | | | | | |
| Width direction length w1 | 30% | 30% | 30% | 30% | 30% | 30% |
| of apex/width direction | | | | | | |
| length W of block | | | | | | |
| Circumferential direction | 30% | 30% | 30% | 30% | 30% | 30% |
| length l1 of apex/ | | | | | | |
| circumferential direction | | | | | | |
| length L of block | | | | | | |
| Position of apex of | Intermidiate | Intermidiate | Intermidiate | Intermidiate | Intermidiate | Intermidiate |
| protrusion (trisection) | portion | portion | portion | portion | portion | portion |
| Radial height h of apex | 1.0 mm | 1.0 mm | 1.0 mm | 1.0 mm | 1.0 mm | 1.0 mm |
| Radial height h of apex/ | 0.020 | 0.020 | 0.020 | 0.020 | 0.020 | 0.020 |
| width direction length | | | | | | |
| W of block | | | | | | |
| Width direction length | 40% | 40% | 40% | 40% | 40% | 40% |
| W of block/ground contact | | | | | | |
| width TW of tire | | | | | | |
| Circumferential direction | 34% | 50% | 40% | 45% | 44% | 44% |
| length L of block/ground | | | | | | |
| contact length TL of tire | | | | | | |
| Width direction length W | 50 mm | 50 mm | 50 mm | 50 mm | 34 mm | 49 mm |
| of block | | | | | | |
| Circumferential direction | 50 mm | 50 mm | 50 mm | 50 mm | 30 mm | 45 mm |
| length L of block | | | | | | |
| Drainage performance | 140 | 135 | 140 | 139 | 142 | 141 |
| Braking performance | 103.5 | 105 | 107 | 110 | 103.5 | 109 |
| Turning performance | 107 | 107 | 107.5 | 109 | 106 | 109 |
| Remarks | Example | Example | Example | Example | Example | Example |

As can be seen from Table 1, the tires according to Examples are all better in drainage performance, braking performance and turning performance than those of Sample Tire 1.

Therefore, Examples of the present disclosure is capable of providing a tire with equalized ground contact pressure distribution and improved drainage performance, braking performance and turning performance.

### REFERENCE SIGNS LIST

1 Tread surface
2 Circumferential groove
20 Edge of circumferential groove 2
3a, 3b Land portion
4 Width direction groove
4a Sipe portion
4b Groove portion
40 Edge of width direction groove 4
5 Block
6 Apex
7a, 7b Circumferential groove
8 Central land portion
9a, 9b Shoulder land portion
10 Width direction groove
10a Sipe portion
10b Groove portion
10c, 10d Chamfer
11 Sipe
11c, 11d Chamfer
12, 13 Block
CL Tire equator
TE Tread edge

1. A tire, comprising
a tread surface divided into a plurality of land portions by at least one circumferential groove extending along a tire equator and tread edges, wherein
at least one of the land portions divided by the at least one circumferential groove and the tread edges comprises a plurality of blocks divided by a plurality of width direction grooves;
each of the blocks has a shape that protrudes from four sides toward a central portion; and
each of the width direction grooves comprises a sipe portion.

2. The tire according to claim 1, wherein
the sipe portion is located at a tire equator side.

3. The tire according to claim 1, wherein
the sipe portion has a longitudinal direction length that is 30 to 90% of a longitudinal direction length of the width direction groove.

4. The tire according to claim 1, wherein
the sipe portion has an opening width of 0.5 mm or less.

5. The tire according to claim 1, wherein
each of the blocks comprises a protrusion with an apex having an area that is ¼ or less of an area of the block.

6. The tire according to claim 1, wherein
each of the blocks comprises a protrusion with an apex having a tread width direction maximum length that is 30% to 40% of a tread width direction length of the block; and
the apex has a tread circumferential direction maximum length that is 30% to 40% of a tread circumferential direction length of the block.

7. The tire according to claim 1, wherein
each of the blocks comprises a protrusion with an apex being located at an overlapping region between an intermediate portion when the blocks are each equally divided into three in a tread width direction and an intermediate portion when the blocks are each equally divided into three in a tread circumferential direction.

8. The tire according to claim 1, wherein
a tire radial height from an opening edge of each of the width direction grooves to the apex is 0.01 or more and 0.023 or less with respect to a width direction length of each of the blocks.

9. The tire according to claim 1, wherein
a tire radial height from an opening edge of each of the width direction grooves to the apex is 0.5 mm to 1.5 mm.

10. The tire according to claim 1, wherein
each of the blocks has a tread width direction length that is 28% to 70% of a tire ground contact width.

11. The tire according to claim 1, wherein
each of the blocks has a tread circumferential direction length that is 35% to 49% of a tire ground contact length.

12. The tire according to claim 1, wherein
each of the blocks has a tread width direction length and a tread circumferential direction length that are both 35 mm or more.

13. The tire according to claim 2, wherein
the sipe portion has a longitudinal direction length that is 30 to 90% of a longitudinal direction length of the width direction groove.

14. The tire according to claim 2, wherein
the sipe portion has an opening width of 0.5 mm or less.

15. The tire according to claim 2, wherein
each of the blocks comprises a protrusion with an apex having an area that is ¼ or less of an area of the block.

16. The tire according to claim 2, wherein
each of the blocks comprises a protrusion with an apex having a tread width direction maximum length that is 30% to 40% of a tread width direction length of the block; and
the apex has a tread circumferential direction maximum length that is 30% to 40% of a tread circumferential direction length of the block.

17. The tire according to claim 2, wherein
each of the blocks comprises a protrusion with an apex being located at an overlapping region between an intermediate portion when the blocks are each equally divided into three in a tread width direction and an intermediate portion when the blocks are each equally divided into three in a tread circumferential direction.

18. The tire according to claim 2, wherein
a tire radial height from an opening edge of each of the width direction grooves to the apex is 0.01 or more and 0.023 or less with respect to a width direction length of each of the blocks.

19. The tire according to claim 2, wherein
a tire radial height from an opening edge of each of the width direction grooves to the apex is 0.5 mm to 1.5 mm.

20. The tire according to claim 2, wherein
each of the blocks has a tread width direction length that is 28% to 70% of a tire ground contact width.
